(19) United States
(12) Patent Application Publication
(10) Pub. No.: US 2016/0162554 A1
(43) Pub. Date: Jun. 9, 2016

(54) METHODS FOR APPLYING TEXT MINING TO IDENTIFY AND VISUALIZE INTERACTIONS WITH COMPLEX SYSTEMS

(71) Applicant: GM GLOBAL TECHNOLOGY OPERATIONS LLC, DETROIT, MI (US)

(72) Inventors: JOSEPH A. DONNDELINGER, DEARBORN, MI (US); KENNETH R. DUBOIS, MACOMB, MI (US); DANA S. BUXTON, SHELBY TOWNSHIP, MI (US); JOHN A. CAFEO, FARMINGTON, MI (US)

(21) Appl. No.: 14/563,354

(22) Filed: Dec. 8, 2014

(51) Int. Cl. G06F 17/30

(52) U.S. Cl. CPC G06F 17/30539

(57) ABSTRACT

A method of detecting textual and behavioral commonalities in warranty reported data. Extracting, by a processor, records of verbatim data from a memory storage unit. A first set of basewords is identified for comparison with the extracted records. A binary flag is set in response to an occurrence of a respective baseword in a respective record. An occurrence matrix is generated that includes entries identifying a number of times basewords are identified in each record. The occurrence matrix is formatted to a format as identified by the user.

### BACKGROUND OF INVENTION

An embodiment relates generally to text mining.

Service verbatims found in warranty data and service repair procedures are used by various personnel to identify ongoing problems with a part of system. The verbatims include various documents that include customer comments and complaints, service personnel comments, and service personnel corrections information. Due to the number of records of the customer and service verbatims, a person attempting to analyze all the records in attempt to find commonality in any of the records would find it too complex and time consuming. Identifying keywords and then manually searching for those keywords are time consuming and costly due to the personnel's time involved. Moreover, when higher order analysis is performed, the time and cost increases dramatically. Moreover, after a person analyzes the data and makes a record of their analysis, anyone else utilizing the data must view the data in the form the personnel analyzing the data formatted the output records. As a result, some formats may not be as pleasing or easy to understand due to an individual's specific liking to a format. As a result, a user would have to reformat the data which may require re-analyzing all the data.

### SUMMARY OF INVENTION

An advantage of an embodiment is an automatic identification and visualization of interaction between elements and behaviors with a complex system. The system and techniques as described herein extend text mining capability from identification of terms to identification of relationships between textual terms. The visualization methods described herein advantageously communicate the magnitudes of the differences in relationships based on frequency counts in the data. The analysis of the data also allows for prioritization of work tasks and automatic generation of certain portions of failure mode documents such as DFMEAs and robustness plans.

An embodiment contemplates a method of detecting textual and behavioral commonalities in warranty reported data. Extracting, by a processor, records of verbatim data from a memory storage unit. A first set of basewords is identified for comparison with the extracted records. A binary flag is set in response to an occurrence of a respective baseword in a respective record. An occurrence matrix is generated that includes entries identifying a number of times basewords are identified in each record. The occurrence matrix is formatted to a format as identified by the user.

### BRIEF DESCRIPTION OF DRAWINGS

FIG. 1 is a block diagram of a service database mining system.

FIG. 2 is a process flow for text mining and forming a relationship matrix.

FIG. 3 is an example of a binary matrix representation correlating verbatim and selected ontology basewords.

FIG. 4 is an example of a generated frequency mapping matrix.

FIG. 5 is an exemplary matrix utilizing a heat map technique.

FIG. 6 is an exemplary matrix utilizing a zero suppression technique.

FIG. 7 is an exemplary matrix utilizing a Gaussian elimination technique.

FIG. 8 is an exemplary matrix utilizing a redundant elimination entry technique.

FIG. 9 is an exemplary matrix illustrating a Pareto technique.

FIG. 10 is an exemplary matrix utilizing a nesting operation technique.

FIG. 11 is an illustration of autonomous auto fill technique for a failure mode effects document.

### DETAILED DESCRIPTION

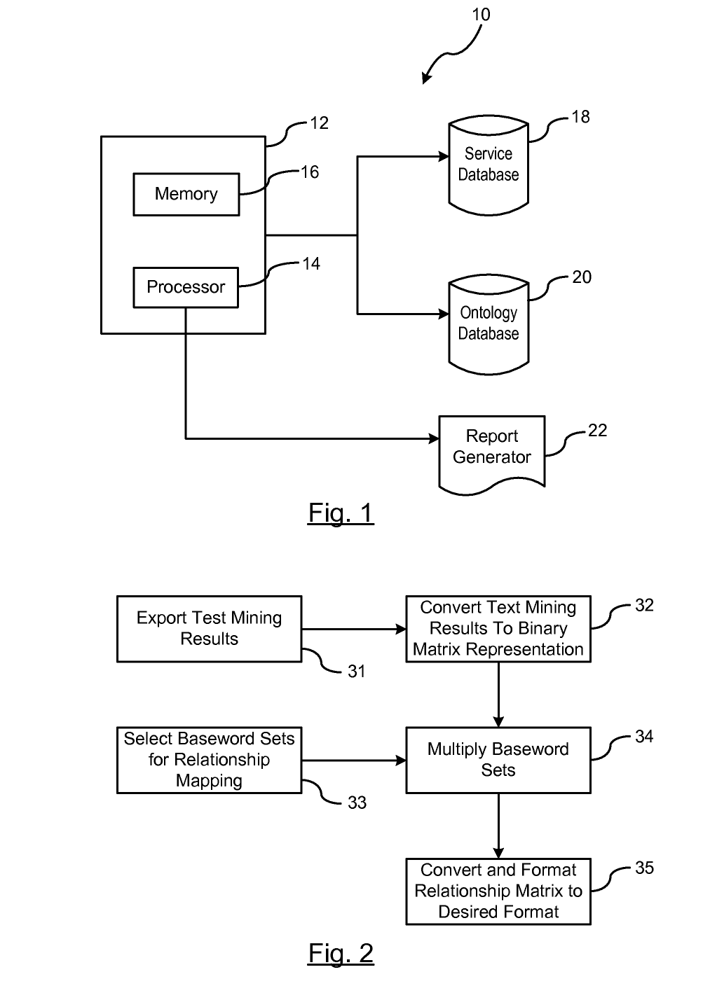

There is shown in FIG. 1 service database mining system 10 for finding textual commonalities in verbatim information. The system 10 utilizes a matrix-based approach for detecting the textual commonalities in the verbatim information. A server 12 includes a microprocessor 14 and a memory storage device 16. The microprocessor 14 is a multipurpose, programmable device that is capable of receiving input data, processing the information according to readable instructions that are stored in its internal memory, and generating an output that is formatted to the user request. The microprocessor may also utilize the memory of the memory storage device 16 that is external to the microprocessor 16 for temporarily storing data that is used by the microprocessor. The microprocessor 14 as will be discussed later receives document data and applies the data for automatically generating documentation tools that includes, but is not limited to, design failure mode effects and analysis tools.

The system 10 further includes a service information database 18 and an ontology database 20. It should be understood that while examples herein may provide details regarding system and components of vehicles, the techniques applied herein can be utilized with any type of warranty reporting system including those non-vehicle related. Moreover, the system is not limited to warranty reporting systems but may include any type of data retrieval system where verbatim are obtained such as product usage and service data. The service information database 18 includes service documents. The service documents may include a single document or a multiple service documents. The documents are service diagnostic procedures or service repair procedures containing verbatim data that are retrieved from the service information database for finding semantic mismatches in the service documents.

The ontology database 20 includes a list of ontology basewords including terms that are proper names of textual terms used in the verbatim data. The textual terms include names of parts, components, subsystems, systems, defects, or undesirable conditions that are commonly utilized in the verbatim. It should be understood that although one term (e.g., component) is used herein for exemplary purposes, textural terms may further include, but are not limited to, parts, subsystems, and systems, defects, and undesirable conditions which may be substituted herein.

A report generator 22 may be used to output reports generated by the processor 14 utilizing the techniques described herein.

FIG. 2 illustrates a process flow for text mining and forming a relationship matrix.

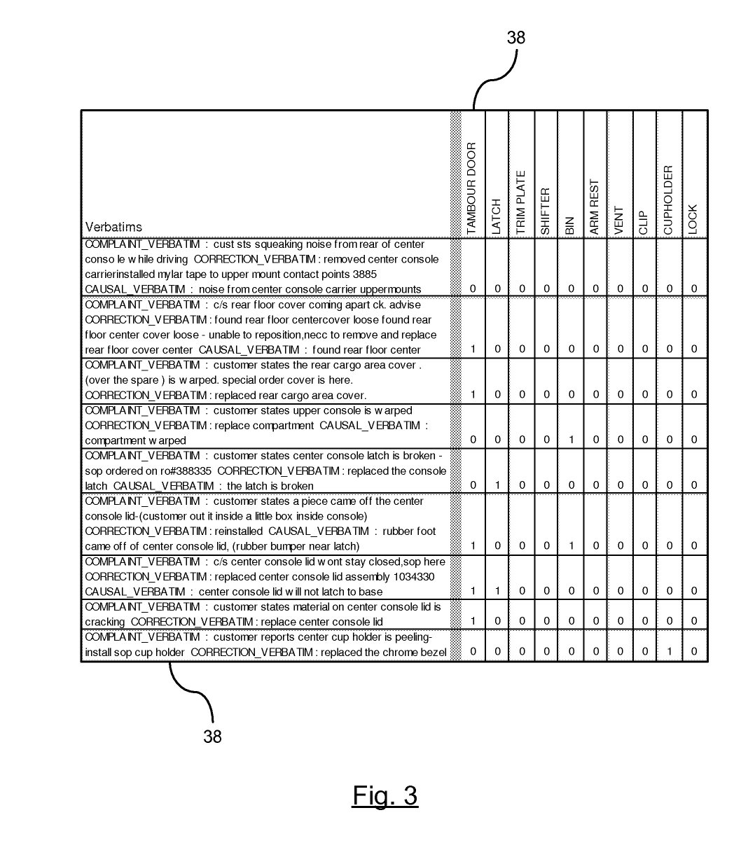

In block 31, text mining results are exported from a service information database along with the ontology basewords from the ontology database. The exported results may be obtained directly from a raw database or may be filtered by an interim tool that processes the verbatims into a format that are usable by the system. FIG. 3 shows an exemplary table illustrating results exported from the service mining database and the ontology database. Verbatims 38 are shown in the form of customer complaints, corrective action comments, and causal comments. The verbatims 38 are listed in rows of tables and are hereinafter referred to as records. It should be understood that the number of records as illustrated are only exemplary to generally show details of the information contained in each record verbatim. Ontology basewords 39 are shown in the columns of the table illustrated in FIG. 3. Such basewords are terms selected by the user that have a relationship with the part, component, subsystem, system, defect, or undesirable conditions that is being analyzed by the user via the exported records. The basewords selected may be all the basewords associated with the respective part, component, subsystem, system, defect, or undesirable conditions analyzed or may be filtered utilizing the user's preferred textual terms. This allows the user to tailor the matrix to a more confined set of textual terms. However, it should be understood that a user has the sole discretion to generate the relationship mapping matrix to any given size as desired.

In block 32, the text mining results are converted to a binary matrix representation. The binary matrix representation is illustrated in the table of FIG. 3. As described earlier, the ontology basewords 39 are listed in columns and the verbatims 38 are listed in rows within the binary matrix representation. A respective binary representation is illustrated at each cross section for a respective verbatim and baseword. Each respective field identified with a “0” indicates that the baseword identified in the respective column does not occur in the verbatim identified in the respective record row. Each respective field identified with a “1” indicates that the baseword identified in the respective column does occur in the verbatim identified in the respective record row.

In block 33, baseword sets are selected for relationship mapping for setting binary flags.

In block 34, a relationship occurrence matrix is generated utilizing two sets of basewords. The two sets of basewords may be set up as matrices and the two matrices are multiplied by one another for determining a match. For each multiplication process, one of the baseword set matrices is transposed prior to the multiplication operation. For example, a first baseword set is represented by B₁ and the second baseword set is represented by B₂. The interaction between the two baseword sets B₁ and B₂ is represented by the following formula:

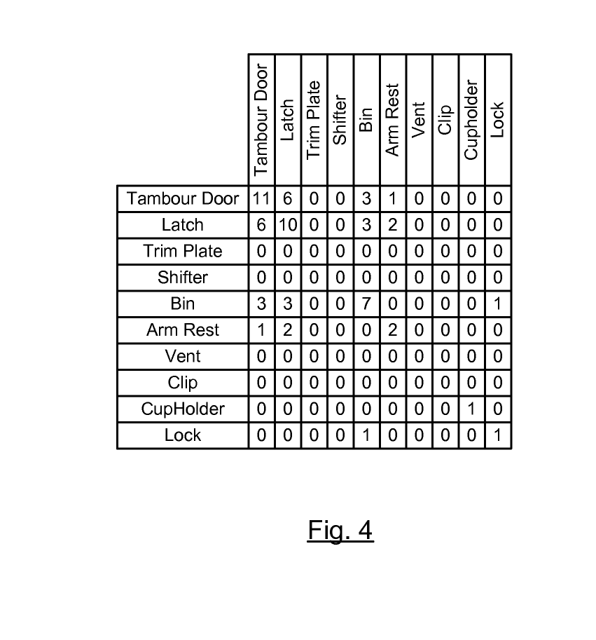

(B₁^{T})(B₂)

where B₁^{T} is a transpose of B₁. This provides a logical “AND” operation between the flags of the two baseword sets. As a result, a “1” will result only if both baseword sets are flagged as “1” which indicates that match within a record is present. The results are tallied in a mapping between the respective baseword sets. The mapping sums the number of times a match occurred between the respective baseword sets. This is illustrated in FIG. 4. In addition, it is shown that in FIG. 4 that the resulting occurrence matrix is essentially symmetrical, which indicates the same baseword sets were utilized.

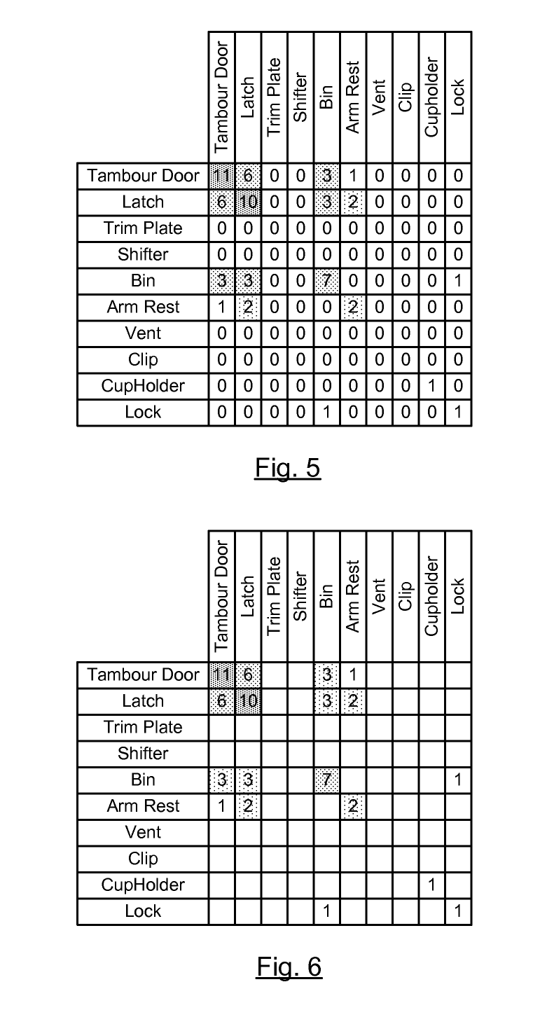

In block 35, the output of the relationship matrix is converted to an ordered list representation. Formats may be applied to generate reports desired by the user. FIGS. 5-8 illustrate potential enhancements that may be applied to the resulting matrix. In FIG. 5, a heat map is shown. The heat map applies conditional color coding to the matrix elements for indicating those areas having increased interactions for respective basewords. The heat map may be color coded to show those areas that are more heavily concentrated with matches than other areas. Those areas with minimum counts have less intensified coloring or shading than those areas with larger counts. For illustrative purposes in FIG. 5-8, the shaded regions indicate regions of increased interaction. Those regions that are more heavily shaded result in increased interaction. Under color schemes, varying degrees of colors may be applied to the matrix with a legend that indicates the degree of interaction that the color represents.

FIG. 6 illustrates a technique where those interactions that resulted in “0” are suppressed from the matrix (e.g., left blank in the matrix). This may be more visually pleasing to a user to allow the user to identify and readily focus on those interactions that resulted in matching interaction. As illustrated in FIG. 6, all the “0” are suppressed by removing them from the matrix and only the interactions where at least one match was recorded remain in the matrix.

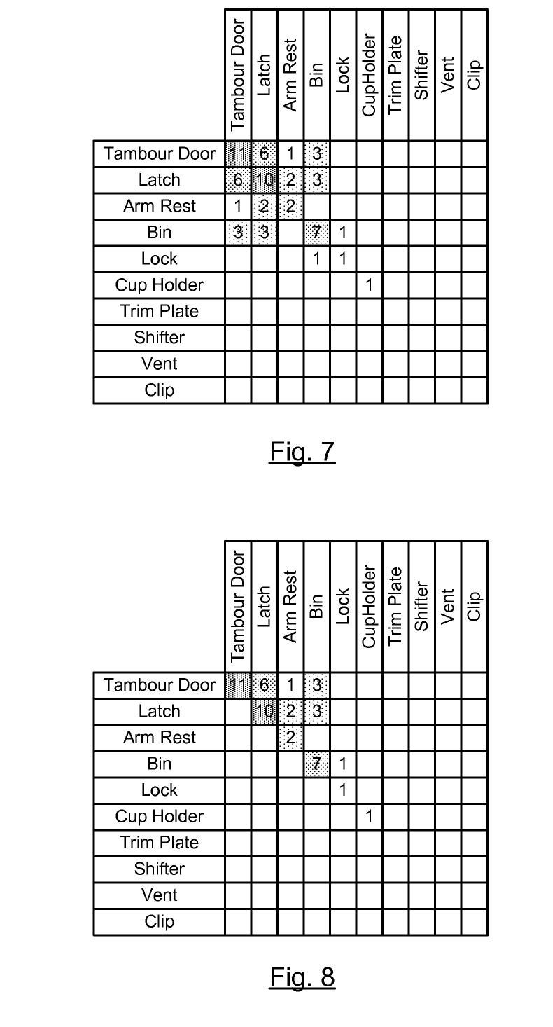

FIG. 7 illustrates a resulting matrix where a Gaussian elimination technique is applied to cluster the results to respective portion of the matrix, typically the upper left portion of the matrix. Those interactions which resulted in a “0” are forced to the lower portion of the matrix and those interactions with at least one interaction are forced to the upper left portion of the matrix. It should be understood that the interaction number for distinguishing whether an entry are forced to a respective region may be a predetermined number other than “0” if desired by the user.

FIG. 8 illustrates a resulting matrix where redundant entries are eliminated (i.e., left blank in the matrix). Since a matrix is essentially symmetric, entries on one portion of the symmetric matrix may be eliminated. An imaginary diagonal line extends from an upper left corner of the matrix to a lower right corner of the matrix. Values on one side of the imaginary diagonal line are maintained while values on an opposite side of the imaginary diagonal line are suppressed.

FIG. 9 illustrates a table where the interaction counts from binary matrix representation are displayed in a list format. The list format may be sorted in an increasing or decreasing order of frequency to illustrate a Pareto distribution of interactions. As noted FIG. 9, the exemplary Pareto as illustrated identifies that the ordered frequency occurrences from highest to lowest.

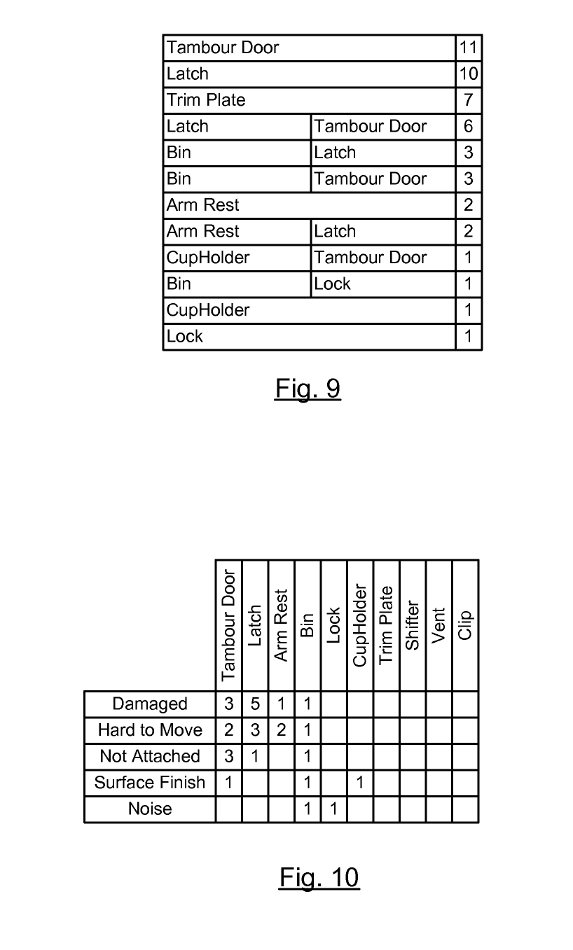

FIG. 10 illustrates a nesting operation where pair wise interactions from the Pareto table are concatenated and used as basewords to generate additional matrices illustrating new heat maps for higher order interactions. As shown in FIG. 10, the baseword nesting allows for generation of two-dimensional reports providing additional details illustrating higher order illustrations. This may be performed by correlating the basewords (e.g., additional multiplication operations) originally selected or basewords from the occurrence matrix that were found to exist in the records with a next set of basewords that provide enhanced detail of the warranty claims such symptoms or causal factors (e.g. defect, fault, undesirable appearance, undesirable operation/function). It should be understood that the respective basewords selected from a previously generated occurrence matrix may include a single baseword (e.g. tambour door) or a combination baseword (e.g., tambour door & latch) for correlation with the next set of basewords (e.g., damaged, hard to move, not attached).

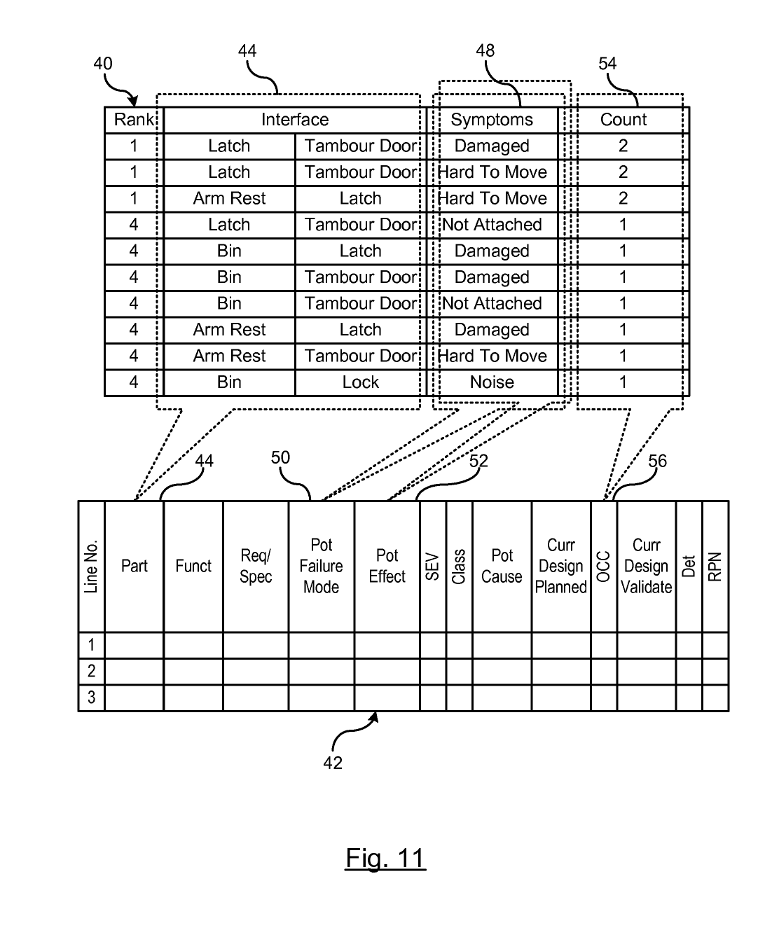

FIG. 11 illustrates an auto fill technique for a failure mode effects document. A Pareto table 40 identifies interfaces components, symptoms, and the frequency count for interactions between the interface device and the symptoms. A design failure mode effects and analysis (DFMEA) worksheet 42 is a tool for evaluating a design for robustness against potential failures and is often the first step of a system reliability study. A plurality of many components, assemblies, and subsystems are evaluated to identify failure modes, and their causes and effects. For each respective component of an assembly (or step of a process), the failure modes and their resulting effects on the rest of the system are recorded in a specific FMEA worksheet.

As illustrated in FIG. 11, the respective components, symptoms, and frequency counts identified in the Pareto table 40 may be autonomously copied and entered into the FMEA worksheet 42. For example, interface components 44 of the Pareto table 40 are autonomously entered into a parts field 46 of the DFMEA worksheet 42. Similarly, symptoms 48 from the Pareto table 40 are autonomously entered into potential failure modes field 50 and potential effects field 52 of the DFMEA worksheet 42. In additional, a count field 54 from the Pareto table 40 is autonomously entered into an occurrence field 56 in the DFMEA worksheet 42. The data may be copied and entered utilizing the processor and memory described in FIG. 1, as well as outputting the DFMEA worksheet utilizing the report generator.

While certain embodiments of the present invention have been described in detail, those familiar with the art to which this invention relates will recognize various alternative designs and embodiments for practicing the invention as defined by the following claims.

What is claimed is:

1. A method of detecting textual and behavioral commonalities in warranty reported data, the method comprising the steps of:
extracting, by a processor, records of verbatim data from a memory storage unit;
identifying a first set of basewords for comparison with the extracted records;
setting a binary flag in response to an occurrence of a respective baseword in a respective record;
generating an occurrence matrix that includes entries identifying a number of times basewords are identified in each record;
formatting the occurrence matrix to a format identified by a user.

2. The method of claim 1 wherein the occurrence matrix is structured as a row of basewords and a column of basewords.

3. The method of claim 2 wherein each entry in the occurrence matrix identifying the number of times a combination of basewords are identified in each record includes a count of a number of records that contain both the respective row baseword and column baseword.

4. The method of claim 3 wherein the occurrence matrix identifies a count indicating the number of records that a respective baseword is utilized.

5. The method of claim 4 wherein the occurrence matrix identifies a count indicating the number of records that two different basewords are used in combination.

6. The method of claim 3 further comprising a second occurrence matrix, wherein the second occurrence matrix includes a second set of basewords selected by the user and basewords identified from the first set of basewords having a count of at least one in the first occurrence matrix, wherein the second set of basewords are different that the first set of basewords.

7. The method of claim 6 wherein the first set of basewords includes a component and the second set of basewords identify a defect associated with the component.

8. The method of claim 6 wherein the first set of basewords includes a component and the second set of basewords identify an undesirable condition associated with the component.

9. The method of claim of claim 6 wherein the basewords identified from the first set of basewords having a count of at least one in the first occurrence matrix is a baseword that is in a row and a column.

10. The method of claim of claim 6 wherein the basewords identified as having a count of at least one in the first occurrence matrix includes baseword combinations obtained from the respective rows and the respective columns.

11. The method of claim 1 wherein the matrix format includes a heat map identifying varying degrees of interactions between respective basewords, wherein the heat map differentiates respective counts with intensified markings, wherein the markings intensify as the count increases.

12. The method of claim 11 wherein the intensification of the marking is identified utilizing a shading scheme.

13. The method of claim 11 wherein the intensification of the marking is identified utilizing a color scheme.

14. The method of claim 1 wherein a suppression technique is applied to format the matrix, wherein respective entries where counts are equal to zero are blank in the occurrence matrix.

15. The method of claim 1 wherein a redundant entry technique is applied to format the matrix, wherein respective entries identified as redundant based on same combinations within the occurrence matrix are blank.

16. The method of claim 1 wherein a Gaussian elimination technique is applied to format the matrix, wherein respective entries having a count less than a predetermined number are moved to a bottom portion of the matrix, and wherein those respective entries having a count equal to or greater than a predetermined number are moved to an upper portion of the matrix.

17. The method of claim 1 wherein the matrix is formatted in a Pareto distribution format.

18. The method of claim 1 further comprising the steps of autonomously generating a failure mode effects document, wherein the data from the occurrence matrix is autonomously mapped to the failure mode effects document.

19. The method of claim 1 wherein the first matrix is symmetric to the second matrix in an untransposed state.

20. The method of claim 19 wherein the first matrix is transposed, and wherein the occurrence matrix is generated as a function of the transposed first matrix and the second matrix.

21. The method of claim 1 wherein the first matrix is asymmetric to the second matrix in an untransposed state.
